(19) United States
(12) Patent Application Publication
(10) Pub. No.: US 2010/0100506 A1
(43) Pub. Date: Apr. 22, 2010

(54) DYNAMIC PRICING SYSTEM AND METHOD

(76) Inventor: Emmanuel Marot, Mercer Island, WA (US)

Correspondence Address: AXIOS LAW GROUP. PLLC, 1525 4TH AVE, STE 800, SEATTLE, WA, 98101-1648, US

(21) Appl. No.: 12/580,501

(22) Filed: Oct. 16, 2009

Related U.S. Application Data
(60) Provisional application No. 61/106,114, filed on Oct. 16, 2008.

(51) Int. Cl. G06Q 10/00

(52) U.S. Cl. 705/400

(57) ABSTRACT

A system and method for providing dynamic pricing are provided herein.

### CROSS REFERENCE TO RELATED APPLICATIONS

This application claims the benefit of priority to U.S. Provisional Application No. 61/106,114, filed Oct. 16, 2008, titled “DYNAMIC PRICING SYSTEM AND METHOD,” naming inventor Emmanuel Marot, and having Attorney Docket No. VALU-2008002. The above-cited application is incorporated herein by reference in its entirety, for all purposes.

### FIELD

The present invention relates to dynamic pricing, and more particularly to a system and method for determining dynamic prices for one or more goods.

### BACKGROUND

Price is a key component of most commercial transactions. Several methods exist today to determine prices, all with their own drawbacks.

Haggling

One method is ‘Haggling’, in which both parties negotiate the transaction price, the Buyer progressively raising her price while the Seller is lowering his. The system is generally used when a ‘referential’ price does not exist or when the negotiation margin is high, for instance during garage sales. Haggling is very time consuming and does not generally allow for a repeat of transactions, as each new transaction requires a new haggling process. Some buyers are also uncomfortable with the process of haggling.

Auctions

Another system is ‘Auction,’ in which the price is not necessarily defined à priori and participants set up the price while competing against each other. Auctions types include ‘English’ auctions, where the bids are open (i.e., known to every bidder) and increasing. ‘Dutch’ auctions are a type of auction where the price is lowered at a predefined rate over time until some participant is willing to buy. Potential buyers may wait to obtain a lower price, but run the risk of having somebody else buy it while doing so. One drawback of auctions is that they do not allow immediate purchases, as the auction has to be completed. Even Dutch auctions, where the purchase can be immediate, require some auctioning time, as the Seller often starts with a peculiarly high price. Another drawback of auctions is they are somewhat complex, and both participants (Buyers and Sellers) may not fully understand all their intricacies or do not feel at ease. Yet another drawback is that auctions bring a significant amount of uncertainty, both for Buyers and Sellers, regarding the final price. A known effect, called the ‘Winner's Curse’ stands for the fact that the winner in an auction may be paying too much, as by definition she had to pay more than every other participant to get the auctioned item.

Yet another problem with auctions is that they require a significant gathering of potential buyers for the price to be satisfying enough for the Seller. If too few potential buyers participate, the final price may be too low compared to the Seller's expectations. Hence, Sellers often must advertise auctions before they start, or extend them to attract more buyers. The problem, then, is the transaction requires even more time before it can be completed, which may be an issue with Buyers.

In an alternative implementation, auctions are ‘double’, meaning the Buyers compete by raising their purchase price while the Sellers compete by lowering their sale price. A transaction occurs as soon as there is a crossover. Such system requires multiple participants on both sides, and is therefore seldom appropriate for a single Seller. As a consequence, Double auctions are traditionally used in very liquid markets, such as a Stock Exchange.

Another type of commonly used auction is the ‘Vickrey auction’. In a Vickrey auction (named after economist and Nobel prize William Vickrey, who studied it), buyers submit private bids. The winner is the highest bidder, but the winner pays only the second-highest price, and not the price of the winning bid. One goal of the Vickrey auction is to simplify the auctioning process, as the best strategy for a participant is to simply and immediately bid at the exact value she puts on the good. From a Seller's perspective, a Vickrey auction is in theory equivalent to an English auction. However, many of the usual drawbacks of auctions may still hamper a Vickrey auction. For instance, it is still necessary to attract sufficient participants, and the transaction requires the auction process to be completed. In a different implementation, the highest bid is made public.

Another drawback of auctions in general is that they are prone to scams, both from the Buyer and the Seller side. For instance, although not technically illegal, the act of ‘sniping’, or waiting until the very last minute to bid is usually frowned upon. Moreover, beginners often do not understand the advantage of waiting until the very last minute for bidding. Another kind of scam is the use of a ‘Shark’ or fake bidder, usually an accomplice of the Seller, who bids solely to artificially raise the price. The Shark can also be a competitor of a potential buyer, interested in having the potential buyer pay a steep price for the good. As a result, another drawback of auctions is consumers may sometimes mistrust them. On the other hand, ‘Shills’ or coalition of Buyers may act together to win an auction at an unfairly low price for the Seller.

Fixed Price

Another type of price determination mechanism is the ‘fixed price’. Although relatively recent (it was introduced only during the 19th Century by Department Stores), it is the way prices are usually set in everyday transactions. Fixed prices are usually considered the most convenient, at least for Buyers. Unfortunately, fixed prices may also bring their own issues. The first one is in the price determination. Because the price is ‘posted’, i.e. publicly disclosed, and fixed, it is crucial for the Seller to set the price correctly. If the price is set too high, the Buyer may decide not to purchase the good. If the price is set too low, the Seller is not getting all the revenue he could from the transaction. Therefore, the Seller may need some guidance or expertise on market averages. A casual seller (e.g., one selling a used good on a Classifieds market) may often lack expertise and may have difficulty determining the correct price. As a consequence, the casual seller may choose to err on the safe side and begin with a high price. From there, buyers and sellers may have to haggle.

As for getting some reference in setting the price, some ‘Blue books’ with price guides exist, but are usually available only for a small set of goods, such as vehicles and collectors' goods. Even professional sellers may lack some of the required expertise. Indeed, it may still be common practice for them to calculate a price by adding a markup on top of a product cost. However, there is little or no economic reasoning for ensuring that such process would give the best possible price, i.e. the one maximizing revenue.

To set better fixed prices, a Seller may need to model the demand for a good, but he may lack sufficient information to do so. Generally speaking, a Seller may be said to never have enough information to define a constant and perfect price a priori because the future is, by essence, unknown. The value of a good may also not remain constant over time; hence the need to occasionally change the ‘fixed’ price. For example, a change in a fixed price may be necessitated by product obsolescence in consumer electronics or by the end of a season ending for sports or fashion goods.

Changes in fixed prices often occur in the form of ‘markdowns,’ which are simple reductions of the fixed, posted prices. It is not unusual, at least in the retail industry, for a good to be marked down multiple times until the entire inventory is sold. Indeed, markdowns play an increasingly important role in retail, as clearance goods now represent about one-third of a typical retailer's sales, up from single digits in the 1970's (New York Times, 2002). Considering the ever-increasing occurrence of sales, promotions, and other specials, one may consider fixed prices to be progressively replaced by dynamic, posted prices.

One problem with markdowns is that the Seller has to decide when, and by how much to markdown a good. Here again, expertise may be required. Another problem is that Buyers may expect such markdowns. Therefore, as Game Theory puts it, Buyers may ‘behave strategically’ by postponing their purchase until the markdown they anticipate is realized. Not only does this strategy lower the amount of sales before the markdown occurs, but it also allows those strategic Buyers to purchase at a lower price than the current value. Another drawback of price drops is that Buyers who make their purchase before the markdown may feel they paid too much and resent the manufacturer or the retailer.

Another issue with a fixed price is that while different Buyers may have different values for the same good, the fixed price will make all Buyers pay an identical price. As a consequence, the Seller may not fully realize the surplus. For instance, let there be 10 potential buyers for a given good, with values distributed uniformly in {$10, $11, . . . , $20}. With a fixed, unique price, the maximum possible revenue is $110 (11 customers at $10 or 10 customers at $11), whereas if it was possible to have each buyer pay its full value price, the revenue would be $10+$11+ . . . +$20=$165.

[Para 19] A method to capture this lost revenue is to ‘price discriminate,’ whether by having different customers pay different prices for the exact same goods (called First-degree price discrimination), by changing the goods slightly to target each customer segment (second-degree), or by dividing customers in identifiable groups (third-degree). First-degree price discrimination is often illegal and usually perceived as unfair by Customers; therefore, it is rarely used. Second-degree is used quite often. However, even though it may increase the theoretical potential revenue, it also tends to make determining the prices even harder, as now there are several goods to be priced. Furthermore, under-pricing or over-pricing a segment may have quite negative consequences. As for third-degree discrimination, its usage is traditionally limited to groups where discounts seem fair to even non-group members, such as Students or Seniors.

Revenue Management (Dynamic Pricing)

One solution to face the complexities of pricing and markdown comes for ‘Revenue Management’; a discipline created thirty years ago in the airline industry. Originally, Revenue Management was focused on allocating various classes of airfares to arriving customers, with the goal of optimizing both the number of seats purchased and their prices, using mathematical models to determine the available inventory for each class, based on parameters such as the number of seats remaining, time until the plane leaves, or historical data. The Revenue Management technique proved quite successful in both increasing the revenue for the Sellers, and giving access to lower price services for more price-conscious customers. Consequently, those methods have been extended to calculating the price itself, and an increasing number of industries have begun using Revenue management. As of today, Dynamic Pricing, as it is also called, is often encountered in the hotel industry, car rentals, utility, toll roads, manufacturing, and retail.

Unfortunately, setting up a Revenue Management system remains a complex and costly task and may require the intervention of multiple experts, economists, mathematicians, and software engineers. As a consequence, such dynamic pricing often remains available only for large corporations. Current dynamic pricing algorithms may also limit the efficacy of existing systems. Moreover, Revenue Management techniques tend to assume that Sellers have an inventory to sell-through. However, such techniques may not be applicable to markets where there is no finite set of inventory, such as a Classifieds market, which needs to attract both Buyers and Sellers, or to digital goods, where inventory may be essentially limitless.

### BRIEF DESCRIPTION OF THE DRAWINGS

FIG. 1 is a diagram illustrating a number of components connected to a network in accordance with one embodiment.

FIG. 2 is a diagram illustrating roles of a dynamic pricing server in accordance with one embodiment.

FIG. 3 is a diagram illustrating relationships between categories, goods, versions, and items in accordance with one embodiment.

FIG. 4 is a flow diagram illustrating the process for determining and/or modifying the Price of a Good in accordance with one embodiment.

FIG. 5 is a block diagram illustrating relationships between variables and calculation steps in accordance with one embodiment.

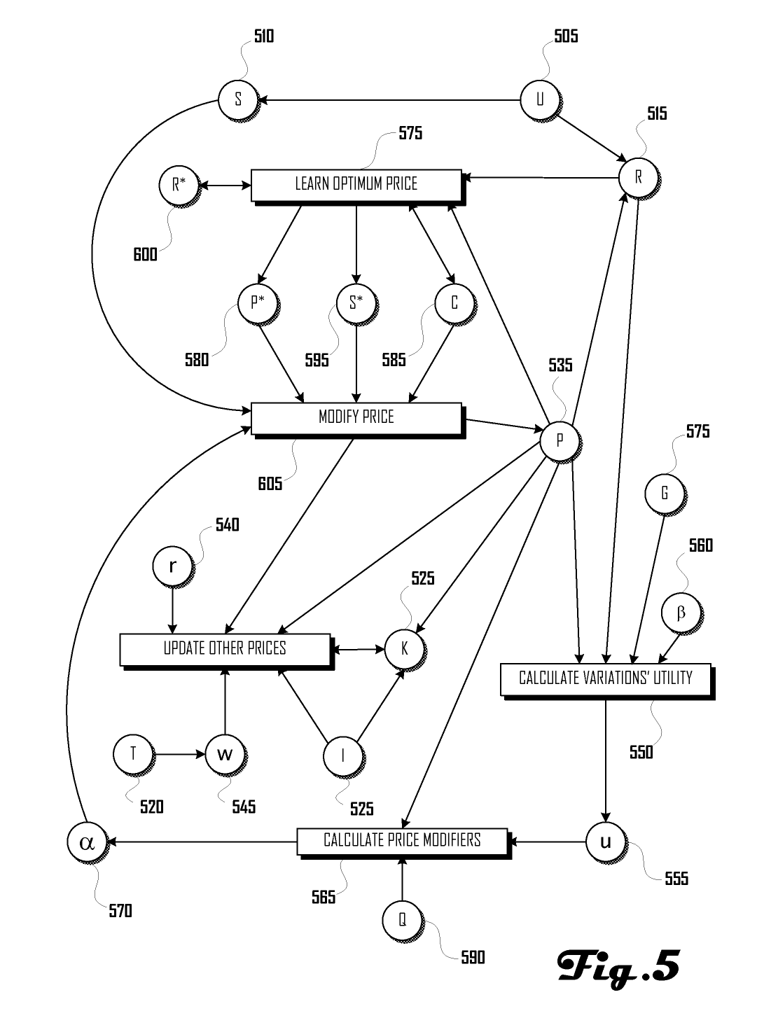

### DESCRIPTION

The detailed description that follows is represented largely in terms of processes and symbolic representations of operations by conventional computer components, including a processor, memory storage devices for the processor, connected display devices, and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

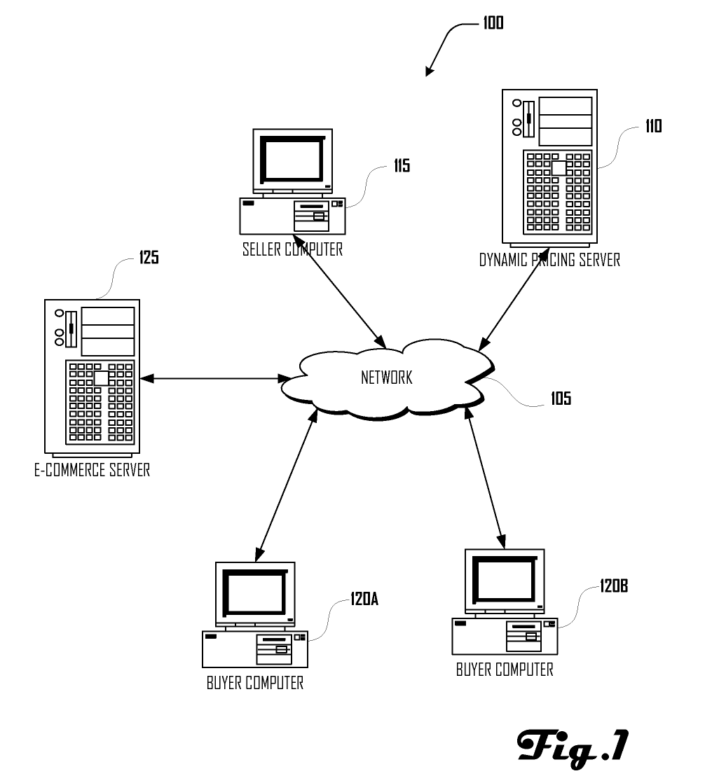

FIG. 1 illustrates an exemplary dynamic pricing environment 100 having a number of devices connected to a network in accordance with an exemplary embodiment. FIG. 1 illustrates a computer 115 operated by a seller, computers 120A-B operated by a number of buyers, an e-commerce server 125, and a dynamic pricing server 110. In further embodiments, the roles of e-commerce server 125 and/or dynamic pricing server 110 may be performed by an integrated device (not shown) or may be distributed across multiple other devices (not shown). In still further embodiments, still additional devices (not shown) may be utilized in the dynamic pricing environment 100. Although only a single seller computer 115 and two buyer computers 120 are illustrated, in many embodiments, there may be multiples of each. In many embodiments, the network 105 may be the Internet.

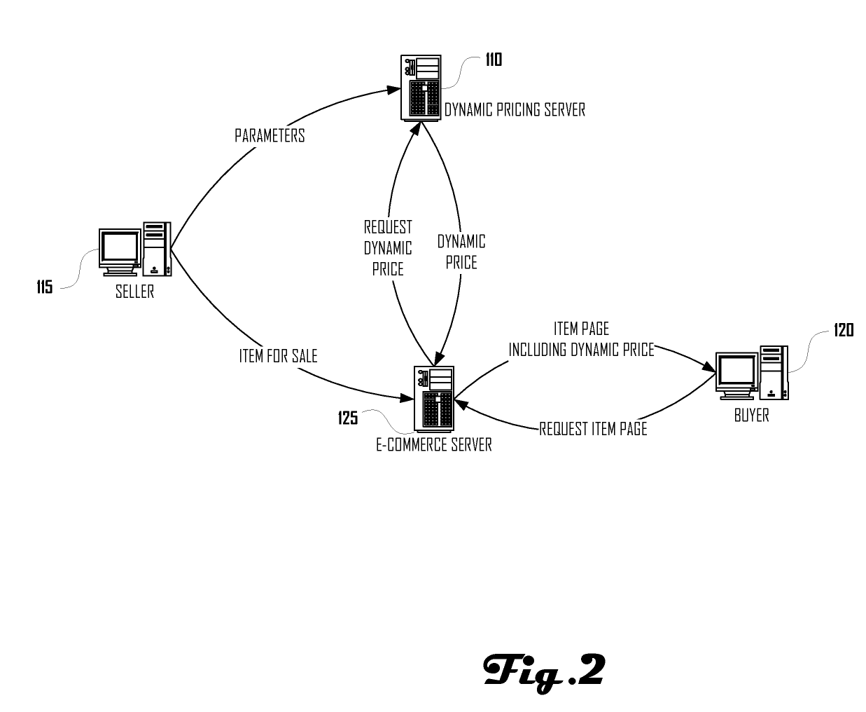

FIG. 2 illustrates a high level overview of an exemplary embodiment, wherein a seller 115 offers an item for sale via an e-commerce server 125. Seller 115 provides parameters to a dynamic pricing server 110, which then provides a dynamic price to a buyer 120 via the e-commerce server 125. This and alternate embodiments are discussed in greater detail below.

Various embodiments concern a Dynamic Pricing Server (hereinafter ‘DPS’) 110. In one embodiment, the DPS 110 may be used to determine the Price of a Good. Herein, the term ‘Good’ is used in its economic sense, referring to a physical product, a non-physical product, a service, or anything of potential economic interest. In various embodiments, the DPS 110 may calculate the Price(s) of one or several Goods in parallel or sequentially, whether those Goods and their Prices are related or not. The DPS 110 may receive one or several Parameters in order to determine the Price. Parameters may comprise initial values (such as an initial inventory level) or updates of those values (such as a variation in the inventory level). In various embodiments, such parameters may include characteristics of the Good, remaining inventory, number of purchases, history of previous purchases and their prices. In various embodiments, the DPS 110 may also generate and/or store data internally independently of the Parameters in order to determine the price and learn from past observations.

In one embodiment, the DPS 110 estimates the ‘Utility’ of multiple variations of a given Good based on observations. Multiple variation of a Good can be worth different prices for Buyers. The DPS 110 observes sales data to estimate the ‘value’ Buyers put in those variations, which is called ‘Utility’ in economics terms. Setting the best possible Price in regard of each Utility is necessary to maximize revenue. The price for each Variation can be expressed as the ‘nominal’ Variation-less Price, multiplied by a variation-specific ‘Price Modifier’. Therefore, the DPS 110 may then seek the optimum Price Modifier for some or all of those Variations. The Price of each Good may then be calculated by, for example, cumulating the Price Modifiers for each of its characteristic Variations may in turn multiply the Price of the reference Good.

In various embodiments, the DPS 110 may provide an interface for the Seller to input the Parameters. In one embodiment, the interface may be a network site allowing the Seller to manually enter or update the Parameters. In another embodiment, the interface may be a semi-automated mechanism, where the Seller uploads the parameters as electronic data into the DPS 110 and the DPS 110 imports those Parameters from the file. In yet another embodiment, the interface may be a fully automated Interface, where the Parameters are sent automatically from a Seller computer 115 to the DPS 110.

Likewise, the Price may be obtained by a User (a User being either a Buyer or a Seller), by manually consulting a website that is hosted by the DPS 110 or that consults data hosted by the DPS 110. The Price may also be obtained by manually or automatically retrieving a given Price tag or downloading a Price list from the DPS 110, or by fully automatically retrieving one or several Prices from the DPS 110 from a computer on the User side. Various embodiments may also automatically retrieve Parameters from an external source, such as an Internet website, which may or may not require any intervention from the Seller. In one embodiment, another set of Parameters can be defined by the Seller, and comprises economic constraints applicable to the Price. Such constraints may be the time by which the inventory should preferably be sold-through, the range of possible prices, the frequency of price change.

In one embodiment, the DPS 110 comprises a Classifieds-like website, providing a market exchange between Buyers and Sellers. In such embodiment, the Parameters of the DPS 110 may be observed directly from its marketplace or taken externally of the marketplace. When used on such an exchange, it may be impossible to fully control the supply, and therefore the ultimate goal may be to determine the ‘market price,’ that is, a price suitable for both Buyers and Sellers and/or consistent with the prices commonly found on other marketplaces, such as competing websites and Classifieds resources.

In some embodiments, the DPS 110 may define a Price in order to get the maximum value from a given Reward mechanism. In one embodiment, such Reward is defined as the Revenue generated by the sale of the Good over a certain period of time. In another embodiment, the Reward is the Revenue generated by the sale of the Good divided by the number of times the Good has been ‘watched’ by Potential buyers, or ‘Views.’ The latest number may be obtained by counting each time a User has seen the product price tag.

In order to prevent fraud, in various embodiments, the DPS 110 may comprise a Repeat Access detection mechanism, where the repeat Views from the same User over a certain period of time will be discarded. In one embodiment, the DPS 110 may discard all data from Users having been detected as repeat viewers.

In one embodiment, the DPS 110 provides the Price to the Seller through an Internet Address specific to this Good and/or Seller. The number of Views can be counted as the number of times this Address has been accessed, discarding Repeat Access.

In one embodiment, the DPS 110 may be used for determining the price of ‘commoditized’ Goods, which are sufficiently similar to observe repeating transactions of the same nature. In another embodiment, the Goods may be less similar, or even unique. In this case, the DPS 110 may eventually not try to determine the Price based on previous transactions, and may instead rely on a method more suitable for unique Goods. One method is to setup an initial high price, and then progressively lower it until someone purchases the Good. However, unlike the ‘Dutch auction’ process, the Price in this embodiment may not decrease over time. Rather, the Price may be based on the number of Views. Consequently, the DPS 110 may not unnecessarily lower the Price when nobody is looking at the Good. In an alternate embodiment, the DPS 110 may try to maintain certain equilibrium between Supply and Demand, by increasing/decreasing the Price when the observed ratio is below/above that equilibrium. In this case, such mechanism could apply to multiple, identical Goods simultaneously.

The DPS 110 may also allow Users to subscribe to an alert system to inform them when a given Good or category of Goods undergoes a Price change. In an embodiment, the DPS 110 may even allow Users to define ‘Options’, alike on a Stock Exchange, to automatically buy a Good or put it for sale when it reaches a certain Price level, or ‘Futures’ to trade the right for buying or selling a Good at a set Price in the future.

Market Structure

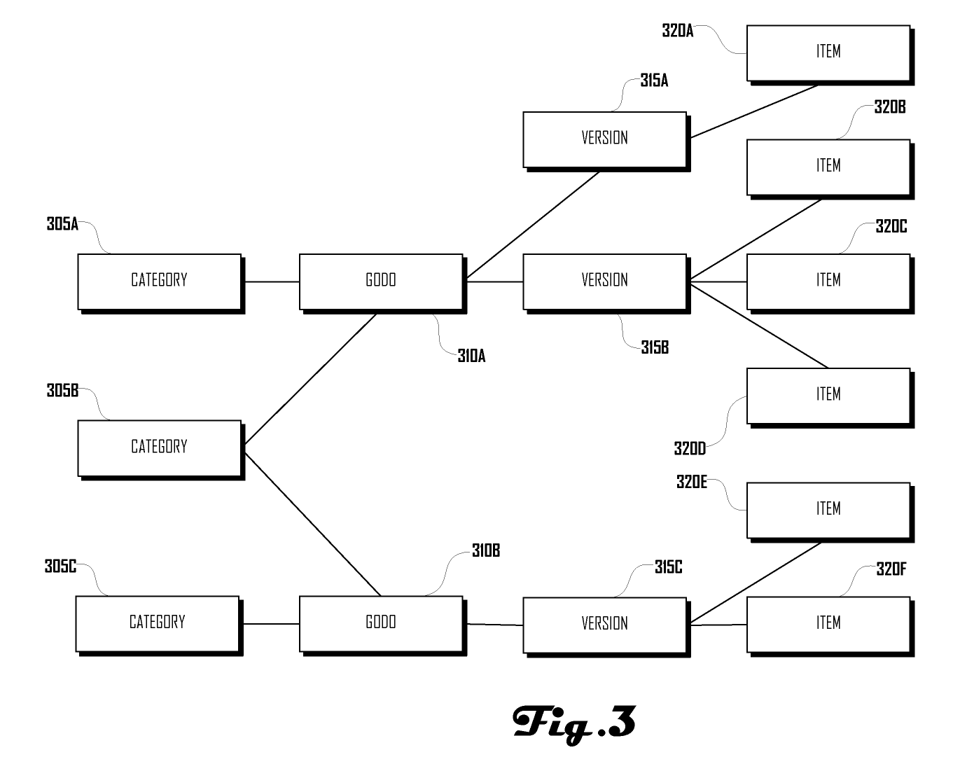

As illustrated in FIG. 3, a ‘Category’ 305 groups several Goods 310A-C, whether in a topology or through common key properties. For instance, the following may be Categories: Video Games, mp3 Players (Good types), Apple (brand), XBOX360 (gaming platform). A given Good 310 can belong to an unlimited number of Categories.

A ‘Version’ 315 is a specific model of a Good 310. A Manufacturer usually defines a unique reference for a Version, such as a Stock Keeping Unit (SKU) or Unified Product Code (UPC). For instance, the Limited Edition of Gears of War or the Orange 8 Gb 4^{th} generation iPod nano may be Versions of, respectively, the video game ‘Gears of War’ and ‘iPod nano 4^{th} generation.’

An ‘Item’ 320 is a specific Version 315, in specific sales conditions. An Item 320 may regroup several products for Sale, as long as they are considered identical. For instance, an Item 320 may be the ‘Gears of War’ video game, in ‘Like New’ condition, available over-the-mail from a Professional Seller located in the USA. In various embodiments, the degree of distinction to separate two Items may vary, based for example on market conditions such as the size of the Inventory.

In another embodiment, the Market is structured around Goods, for which possible Variations can occur. Therefore, the ‘Versions’ and ‘Items’ are expressed as a vector subset of those possible Variations. Such Variations may be continuous (e.g. ‘time since original purchase’) or Boolean in nature (e.g. ‘the product is in like-new condition’).

Smoothing

In order to smooth out observations, the DPS 110 may compute and rely upon Exponential Moving Averages of the various Ratios, Indicators, and any observed data, in lieu of the observed values. For a given number of periods n, the Exponential Moving Average EMA at time t and taking into account the new observation obsₜ is calculated as:

$${EMA}_{t} ← {EMA}_{t - 1} + \frac{2}{n + 1} ( {obs}_{t} - {EMA}_{t - 1} )$$

In one embodiment, n is arbitrarily defined. In another embodiment, n is calculated stochastically, such as to minimize the sum of the squares of the differences between EMAₜ and obs_{t′} where the interval [t′−t] may be chosen arbitrarily and over a subset {t-m, t}, m being an arbitrary value.

In yet another embodiment, Adaptive Moving Averages (AMA) are used to smooth out observations. An Efficiency Ratio α is calculated for n periods such as:

$$α = {( \frac{\vert {obs}_{t} - {obs}_{t - n} \vert}{{\sum }_{i = t}^{t - n} {obs}_{i} - {obs}_{i - 1}} \times a + b )}^{2}$$

Where a and b are two constants (e.g, a=0.6015 and b=0.0645). The AMA may then be calculated as:

AMAₜ←α×obsₜ+(1−α)×AMAₜ₋₁

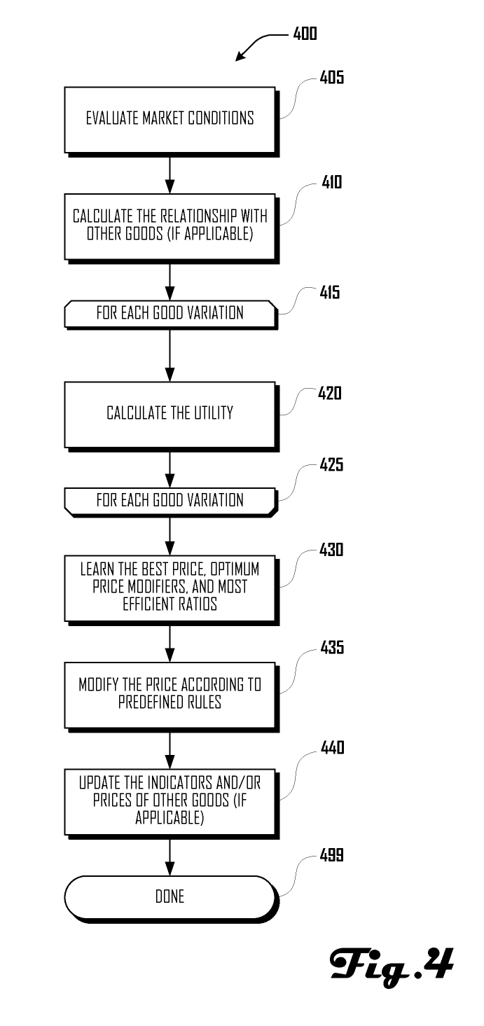

As illustrated in FIG. 4, in one embodiment, a routine 400 for determining and/or modifying the Price of a Good may go through one, several, or all of the following steps: step 405 calculate multiple Ratios to evaluate the market conditions; step 410 calculate the relationship with other Goods, if applicable; steps 415-425 calculate the Utility of each Good variation; step 430 Learn the best Price, optimum Price Modifiers, and most efficient Ratios; step 435 modify the Price according to predefined rules; and step 440 update the indicators and/or Prices of other Goods, if applicable. The routine 400 ends at step 499.

Calculating Ratios

By default, and unless mentioned otherwise or irrelevant, all market Ratios, Indicators, and Indexes are calculated at the Item levels. In alternate embodiments, those Ratios may be calculated at other levels, e.g., at the Version level, Good level, or even Category level. Therefore, as referred to herein, the Ratios, Indicator, and Index calculation methods below will mention only Items, but remains applicable at the upper levels as well.

‘U’ 505 is the ratio measuring the ‘Purchase rate’ and corresponding to the number of purchases of an Item over time interval (t−t₋₁) divided by the number of Views of that Item during the same interval. In other words, U 505 is the number of purchases occurring for every View. For instance, if one sale occurs every 50 Views, then U 505 equals 1/50=0.02. The value U 505 is theoretically independent from the interval length, although such interval may be defined as long enough to discard cyclical variations (e.g. not calculating a low U 505 because it's 4 AM and nobody's buying). If the number of views equals zero, then U 505 is given an arbitrary high value (e.g. 999). In one embodiment, the DPS 110 uses multiple and differentiated intervals and corresponding compensation factors. Based on observed Purchase rate u, of sub-interval i of Period m, the compensated rate u′ᵢ is calculated as:

$${u}_{i}^{′} = {u}_{i} \frac{{\overline{U}}_{M}}{{\overline{U}}_{j}}$$

Where the multiplying factor of uᵢ is the average Purchase rate over period M divided by the average Purchase rate over interval j, j being a past occurrence of interval i.

‘S’ 510 measures the ratio between Supply and Demand. It is computed as the remaining inventory divided by the number of purchases for each view. Therefore S 510 equals the inventory of Items available divided by U 505. For instance, if 10 items remain for sale, and 0.02 are bought for every view on average, then S 510 equals 10/0.02=500. S 510 can be understood as the number of views that will be necessary to sell-through all the inventory. If no purchases occurred and U 505 equals 0, then S 510 is given an arbitrary high value (e.g. 999).

‘R’ 515 is the Revenue Rate. In one embodiment, it is simply calculated as the revenue generated over time interval (t−L₋₁). In another embodiment, it is calculated as the revenue generated over time interval (t−L₋₁) divided by the total corresponding views over the same interval. Therefore it is also equal to the Price multiplied by U 505, and can be understood as the Revenue per view. For instance, a $20 Item purchased once every 50 views will give a R 515 of 20*1/50=$0.04

Calculating Relationships Between Items

In an embodiment, the DPS 110 allows the Price variations of a given Item to modify the Prices of related, yet different Items.

‘T’ 520 is the Traction ratio, or popularity. It is calculated as the number of times an Item is sold over time interval (t−t₋₁) divided by the total of all sales in the marketplace during the same period. For instance, an Item selling once while a total of 200 sales occurred on the marketplace has a T 520 of 1/200=0.005. T 520 is bounded by a minimum constant value Tₘᵢₙ to ensure even Items that are not sold over the period may be taken into account.

Category Price Index I 525 is a measure of the value evolution of the Items within a given Category. An arbitrary value is given for initial Index I₀. For instance, I₀=100.

‘K’ 530 is the coupling indicator. It is a ratio between the Category Price Index I 525 and the Item price P 535. When a new Item is added to a Category at time t, then the initial value of K 530 is calculated by:

$${K}_{t} = \frac{{I}_{t}}{{P}_{t}}$$

For instance, if a $20 Item is added to a Category whose Index I 525 is $100, then K=5. The coupling indicator allows storing the Price ratio between an Item and one Category it belongs to.

‘r’ 540 is a correlation indicator, which measures the amount of correlation between an Item Price P 535 and the Index I 535 of the Category the Item belongs to. It may measure how much the Index I 525 shall follow the changes of an Item Price P 535, and/or how much a change in the Category Index I 525 shall be reflected on an Item Price P 535. An absolute value of 1 (one) means any change in P 535 shall be fully reflected on I 525, or vice-versa. As the absolute value of r 540 tends to 0 (zero), there shall be more independence between the two, and therefore the changes are dampened. If r 540 is negative, changes will be reflected, but in opposite direction. In one embodiment, the value of r 540 for period t is calculated as a correlation coefficient. For instance, using a Pearson correlation coefficient, for n data points, and Pᵢ being respectively the Category Index and Item Price i^{th} observation, having t−n≦i≦t:

$$r = n \frac{n \sum {I}_{i} {P}_{i} - \sum {I}_{i} \sum {P}_{i}}{\sqrt{n \sum {I}_{i}^{2} - {( \sum {I}_{i} )}^{2}} \sqrt{n \sum {P}_{i}^{2} - {( \sum {P}_{i} )}^{2}}}$$

In one embodiment, n is arbitrarily defined. In another embodiment, the value of n is calculated as a function of the Standard Deviation σₘ of the observations over a larger period m. For instance, n=a(σₘ)² where a is a constant.

‘w’ 545 is a weight indicator for ‘moving’ the Category Index I 525, based on the Traction T 520 of the corresponding Item. In one embodiment, a popular Item has more impact on the Index than one that is never traded. w 545 is equal to the traction T 520 of an Item divided by the sum of the all the Tractions of the Items within the Category:

$${w}_{i} = \frac{{T}_{t}}{{\sum }_{j = 1}^{n} {T}_{j}}$$

Calculating the Utility of Good's Variations

In one embodiment, the DPS 110 calculates 550 the Utility u 555 of a Good given its Variations vis-à-vis a Reference Good, such as:

uⱼ=Σβᵢxᵢ+u₀

Where xᵢ is a Variation, β 560 a Utility parameter of this Variation and u₀ the Utility of the Reference Good. The Variations may be continuous (e.g. ‘hours of use’, or ‘Seller's reputation’) or Boolean (e.g. ‘the product is black’, or ‘the box is missing’). In the later case, xᵢ may be equal to 0 or 1.

In one embodiment, the choice model may be Multi-Nomial Logit (MNL), meaning the probability a Customer chooses Variation j of utility uⱼ 555 is equal to:

$$P ( j ) = \frac{{e}^{\frac{{u}_{j}}{μ}}}{\sum {e}^{\frac{u}{μ}} + τ}$$

Where μ is a constant, which may eventually be set to 1, and τ is another constant, which may be equal to 1 or 0, depending upon the decision of considering the Non-purchase as an available choice or not. The DPS 110 may estimate the value of Utility parameters βᵢ 560 for each variation i by corroborating the observations of actual sales with the choice model. One method to do so is to calculate a Maximum-Likehood Estimation through standard nonlinear programming methodologies. In this case, the DPS 110 tries to find the values of β 560 minimizing the difference between observations and MNL estimations.

Once the β 560 have been estimated, the DPS 110 determines 565 the Price Modifiers α 570 for each variation in order to maximize the total Revenue:

$$max {\sum }_{j ∈ S} {P}_{j} ( α , p ) {Q}_{j} ( G , β , {p}_{j} )$$

Where Pⱼ 535 is the price of Good j amongst set of choices, G 575 expressed as a linear function of nominal price p and vector of modifiers α 570, and Q 590 is the demand for the same choice j, based on the set of available choices G 575, estimated vector of utility parameters β 560, and price pⱼ 535. In other embodiments, the DPS 110 may apply the same logic, but rather than optimizing the total Revenue, it may try to minimize the differences between the Revenues of each Variation, to minimize the differences in the Supply/Demand ratio, or to find Pricing Modifiers α 570 maximizing the Likehood of the sale-through of the Inventory of each Variations within a given delay.

In another embodiment, the DPS 110 monitors the Supply/Demand ratio S 510 for each Variation of the Product. When the ratio Sⱼ 510 of a variation j is higher/lower than the average ratio S, the DPS 110 lowers/increases the price Modifier α 570 of the variation j. Such change of the Price Modifier α 570 can be absolute (e.g. ‘increase modifier αⱼ by 0.05 if Sj<S’) or relative (e.g. ‘multiply modifier aⱼ by aSSⱼ⁻¹’ where α is a constant).

Learning the Best Price

In various embodiments, the DPS 110 may try to learn 575 the optimum Price P* 580 that maximizes an observed Reward. In one embodiment, the Reward is equal to R 515. In other embodiments, the Reward may be a combination of Ratios or Indicators. The DPS 110 may also learn the optimum values for various Ratios, i.e. the values of Ratios that are observed when the Price P is close enough to optimum Price P* 580. Unless mentioned otherwise, the letter R 515 will be used thereafter to denote the Reward in general, without limiting R 515 to refer only to the Revenue ratio.

In one embodiment, the DPS 110 tries to measure how confident it should be in its beliefs of the optimum Price. Such Confidence factor C 585 may be determined by observing if moving the Price P 535 towards P* 580 increases or decreases the Reward C 585. Cₘᵢₙ and Cₘₐₓ being respectively the minimum and maximum value of C 585 (e.g. 0 and 1), ε_{c} a step-size parameter, the DPS 110 may calculate a modifier of C 585, Δ_{C}, equal to (Cₘₐₓ−C)* ε_{c} when reducing the distance |P*−P| increases R 515 (or increasing the distance reduces R 515), and equal to (Cₘᵢₙ−C)* ε_{c} when reducing the same distance decreases R 515 (or increasing the distance increases R 515).

In one embodiment, when the current price yields a better Reward R 515 the DPS 110 may learn ‘new’ optimum Price and Ratios. With X representing successively P 535, S 510, and R 515, and where X* denotes the optimum value, respectively, of P* 580, 5* 595 and R*600, Xₜ the current observation and αₓ a constant step-size parameter, the DPS 110 updates its values such as:

X*←X*+α_{X}(Xₜ−X*)

In an alternate embodiment, the DPS 110 also updates C 585, whether inverse proportionally to the relative distance between the previous optimum Price P* 580 and the new one, whether by giving an arbitrary value to the Confidence modifier Δ_{C}.

In one embodiment, the DPS 110 compares the difference between Price P 535 and Optimum Price P* 580 with a constant value δ_{P}. If the difference is smaller than δ_{P}, such as:

$$2 \frac{\vert P - {P}^{*} \vert}{P + {P}^{*}} < {δ}_{p}$$

Then the DPS 110 considers the Price P 535 to be ‘optimum’

When the price P 535 is optimum, the DPS 110 may update the optimum Reward R* 600, α_{R} being a constant step-size parameter and Rₜ being the observed R, such as:

R*←R*+α_{R}(Rₜ−R*)

In an alternate embodiment, when the price P 535 is optimum, the DPS 110 also updates C 585, whether inverse proportionally to the relative distance between the previous optimum Reward R 515 and the new one, whether by giving an arbitrary value to the Confidence modifier Δc.

α_{R} being a constant step-size parameter, and 0<ε₁, ε₂<1 being two arbitrary values, the DPS 110 may then update C 585, such as:

C←max(min(C+α_{C}Δ_{C},1−ε₁),ε₂)

Modifying the Price

In various embodiments, the DPS 110 modifies 605 the Price P 535 based on market ratios and what it learned regarding the Optimum Price P* 580.

In one embodiment, the DPS 110 may follow a ‘Greedy Policy’ trying to maximize R 515 by moving P 535 toward P* 580, or an ‘Exploratory Policy’, deliberately ignoring P* 580 and relying on other methods for modifying P 535.

In one embodiment, the DPS 110 follows a Greedy Policy with a probability equal to C 585, and an Exploratory Policy otherwise.

When following a Greedy Policy, and with a_{P}^{g} being a constant step-size parameter for this Greedy Policy, the DPS 110 may calculate a Price modifier Δ_{P} such as:

Δ_{P}=(P*−P)Cα_{P}^{g}

In another embodiment, the DPS 110 calculates the Price modifier Δ_{P} such as Δ_{P}=δ if P<P* or Δ_{P}=−δ if P>P*, δ being whether an arbitrary constant, a random number between two arbitrary constants λ₁ and λ₂ such as λ₁<δ<λ₂, or a function of the difference between P* 580 and P 535, such as:

$$δ = 1 - {e}^{- \frac{{d}^{2}}{α}}$$

Where α is a constant and d the difference between P* 580 and P 535, whether absolute such as d=P*−P or relative such as:

$$d = 2 \frac{{P}^{*} - P}{{P}^{*} + P}$$

When following an Exploratory Policy, and with α_{P}^{e} being a constant step-size parameter for this Exploratory Policy, the DPS 110 may calculate a Price modifier Δ_{P} such as Δ_{P}=Pα_{P}^{e} if S<S* and Δ_{P}=−Pα_{P}^{e} if S>S. In an embodiment, Δ_{P} is always equal to Pα_{P}^{e} when the inventory of the Item for sale is null.

In another embodiment, when following an Exploratory Policy, given an arbitrary constant λ, Δ_{P} is a random variable between −λ and λ.

Once the DPS 110 has finished calculating Δ_{P}, it may update the Price P 535 within the variation limit of Δₘₐₓ and while ensuring it stays within the limit of Pₘᵢₙ<P<Pₘₐₓ, such as:

P←max(min(P+Δ_{P},P*(1+Δₘₐₓ),Pₘₐₓ),Pₘᵢₙ,P*(1−Δₘₐₓ))

In one embodiment, Pₘₐₓ is calculated as a factor of the Manufacturer's Suggested Retail Price (MSRP), for instance Pₘₐₓ=1.0×MSRP. In another embodiment, Pₘₐₓ may be calculated as factor of the MSRP divided by the ‘Age’ of the Product, where the Age is the time lapse between the Product's initial introduction on the market and the current time. Therefore, t₀ being the launch time, t the current time (both being expressed as a number, such as a Julian date), P₀ being the MSRP at Product launch or the current MSRP at time t, and ζₘₐₓ being an arbitrary constant or being equal to 1+θ where θ is an externally observed interest or actuarial rate, then:

Pₘₐₓ=P₀*ζₘₐₓ^{t-t}^{₀}

In one embodiment, ζₘᵢₙ is calculated with a similar equation, ζₘᵢₙ being replaced by ζₘᵢₙ of superior value.

In all cases, the DPS 110 may ensure that Pₘₐₓ−Pₘᵢₙ>γ or that Pₘₐₓ/Pₘᵢₙ>γ at all times, with γ being an arbitrary constant.

In one embodiment, the DPS 110 returns the price Pⱼ of a Good j comprised of n variations vis-à-vis the nominal Price P 535, each with the corresponding price modifier α 570 such as:

$${P}_{j} = P \times {\sum }_{i = 1}^{n} {α}_{i}$$

In another embodiment, the price modifiers α 570 are multiplied instead of being added, such as:

$${P}_{j} = P \times {\prod }_{i = 1}^{n} {α}_{i}$$

Updating Other Prices

In one embodiment, the change of Price of an Item from P 535 to a new value P′ triggers an update of the Category Indices I 525 it belongs to, each with r 540 being the correlation with a Category, and from their past index I 525 to a new one I′, such as:

$${I}^{′} = I * ( 1 + r \frac{{P}^{′} - P}{P} )$$

In another embodiment, the change from I 525 to a new value I′ takes into account the weight of the Item w 545 within each Category, such as:

$${I}^{′} = I * ( 1 + w * r \frac{{P}^{′} - P}{P} )$$

Once an Index has been changed to a new value I′ of I 525, due to the price modification of a given Item, the coupling of that Item with the Index can be changed to a new value K′ of K 530 such as:

$${K}^{′} = \frac{{I}^{′}}{{P}^{′}}$$

After all Indices changes have been processed, the DPS 110 may affect the Prices of the other Items in each Category. For an Item of Price P 535 belonging to a collection of Categories traversed by i, and coupling Kᵢ 530 vis-à-vis each Category I, which has a new index I′ᵢ, a new value P′ of Price P 535 is calculated such as:

$${P}^{′} = P + \sum {r}_{i} \frac{{I}_{i}^{′} - {K}_{i} P}{{K}_{i}}$$

And each corresponding Coupling K 530 may be subsequently updated such as:

$${K}_{i}^{′} = \frac{{I}_{i}^{′}}{{P}^{′}}$$

Filtering Out Repeat Access

In various embodiments, when the DPS 110 takes into account the Views of a given Item to determine its Price, it may use a method to prevent fraud by filtering out repeat views.

In one embodiment, a unique identifier is linked to each visitor, so that repeated accesses, or views, from that visitor over a certain period of time will be discounted. For instance, the DPS 110 may take into account a maximum of one access per day for each Visitor.

One way to determine this identifier is to log the Internet Protocol (IP) address of the Visitor.

Another way is to put a HTTP cookie on the Visitor's device, so that repeat views from a Visitor with the same cookie will be discarded. To prevent further fraud, views from Visitors not returning an identification cookie, or returning an invalid identification cookie, may be systematically discarded.

To further prevent malicious visitors erasing the Identification cookie in order to be counted as a ‘new’ visitor, the DPS 110 may limit the number of views counted for each ‘recent’ visitor (i.e. a visitor having a recent cookie).

In another embodiment, the DPS 110 automatically discards Visitors whose behaviors are unusual. In such embodiment, the DPS 110 may measure the behaviors of most Visitors (e.g. 95% of them), and would automatically discard Visitors with behaviors outside of such range. For instance, if 95% of Visitors see between 1.5 and 23.6 Goods, anyone looking at 24 Goods or more will be automatically filtered out. The measures taken into account may be, without being limited to: number of Goods seen, duration or frequency of visits, origin of visits.

In order to prevent a collusion of Visitors deliberately and conjointly viewing an Item to lower its price, the DPS 110 may smooth the observation of Views, whether by ignoring any aggregated Views over a maximum of z times the average, z being a decimal number, or by relying upon Exponential or Adaptive Moving Averages rather than direct observations.

Descending Auction-Like Mechanism

In another embodiment, the Price of an Item progressively goes down following Views of Visitor. P₀ being the initial (high) Price, Pₘᵢₙ the minimum price, Van average number of Views over a given time interval (t−t₋₁), d a delay for preferably selling the product expressed as a multiple of the average interval (t−t₋₁), v the total of observed Views over time interval, then the Price P may be calculated as:

$$P = max ( {P}_{0} - ( {P}_{0} - {P}_{min} ) \frac{v}{Vd} , {P}_{min} )$$

In one embodiment, the average number of Views is calculated automatically by the DSP 110, based on smoothed observations.

In another embodiment, Δ_{P} being the theoretical Price decrease amount each time a view occurs, such as:

$${Δ}_{P} = \frac{{P}_{0} - {P}_{min}}{Vd}$$

The real applied price decrease is then equal to ξ_{P}, which is a continuous random variable of mean Δ_{P}. ξ_{P} may be a uniformly distributed and bounded by [0 . . . 2Δ_{P}] or normally distributed and of standard deviation Δ_{P}/2.

Supply/Demand Equilibrium Mechanism

In yet another embodiment, the DPS 110 measures the ratio between Supply and Demand S, as defined previously, for each or a certain Good, with an arbitrary target value S*. If S<S*, the DPS 110 raises the price of the Good by a constant value x₁ whether by adding x₁ to the Price or by multiplying the Price by (1+x₁). Likewise, if S>S*, the DPS 110 lowers the Price of the Good by a constant value x₂, whether by subtracting x₂ to the Price or multiplying the Price by (1−x₂).

Constraining the Price Changes

In one embodiment, the Seller may define parameters constraining the Dynamic Pricing mechanism. He may define a set of acceptable prices, and therefore the DPS 110 will automatically round the Price to the closest value is the set. For instance, if the set of acceptable prices is {$19.90, $25.90, $34.90} and the exact Price determined by the DPS 110 is $23.74, the ‘rounded’ price will be $25.90. In another embodiment, pan-Sellers ‘psychological’ Price levels may be pre-defined in the DPS 110, and the DPS 110 automatically ‘rounds’ the exact Price to those values. In an embodiment, the Seller may define how often the price should change. In this case, the DPS 110 will update the ‘displayed’ price according to the schedule defined by the Seller.

Retrieving Price Tags

In one embodiment, where queried for the Price of a given Good, the DPS 110 may return an image containing the current Price. Therefore, inclusion of a dynamic Price tag from the DPS 110 maybe as simple as linking an image source to a URL specific to the Good on the DPS 110 website. Such method can be used to include the Price on existing markets, distribution channels or Classifieds site. In another embodiment, the Seller may include a JavaScript code snippet within a Web page specific to his Good for sale. Such snippet will dynamically write the real-time Price value within the page by accessing the DPS 110 order to retrieve such value.

In either of the two embodiments aforementioned, the DPS 100 may include a link in the Price tag pointing toward the DPS 100 website, and allowing to retrieve more information about the Good or its Price history.

Alerts and Options

The DPS 110 may provide some tools for the Users to be kept aware of Price changes. In one embodiment, a User may create and maintain a list of Goods, and the DPS 110 may provide updates about Price changes by sending e-mail messages to that User. In another embodiment, the DPS 110 provides a RSS feed of current Prices.

The DPS 110 may also allow Users to define ‘call’ options to purchase a Good in the future, at a pre-defined Price or ‘put’ options to sell a Good in the future at a predefined Price. Users may have to deposit a certain monetary amount in the DPS 110 to be eligible to such options and/or purchase such options. Such options may only be exercised on expiration (so-called ‘European Options’ in Finance). Due to this property, in one embodiment, the DPS 110 may determine the price of such Options by strictly applying the Black-Scholes model for calculating an equity option, and where the continuous yield dividends of the Black-Scholes model may be substituted by an estimated utility value from the use of the Good.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the embodiments discussed herein.

1. A system and method for dynamic pricing, as shown and described.
